(19) United States
(12) Patent Application Publication
(10) Pub. No.: US 2026/0339739 A1
(43) Pub. Date: Oct. 29, 2026

(54) HETEROGENEOUS ACCELERATION METHOD, DEVICE AND SYSTEM, AND STORAGE MEDIUM

(71) Applicant: CLOUD INTELLIGENCE ASSETS HOLDING (SINGAPORE) PRIVATE LIMITED, Singapore (SG)

(72) Inventors: Tengfei LI, Beijing (CN); Liang YOU, Beijing (CN); Xin LONG, Hangzhou, Zhejiang (CN)

(21) Appl. No.: 19/122,223

(22) PCT Filed: Nov. 8, 2023
(86) PCT No.: PCT/CN2023/130331

§ 371 Date: Apr. 17, 2025

(30) Foreign Application Priority Data
Nov. 28, 2022 (CN) 202211505332.6

(51) Int. Cl. G06F 9/50; G06F 16/25

(52) U.S. Cl. CPC G06F 9/5044; G06F 16/258

(57) ABSTRACT

Embodiments of the present application provide a heterogeneous acceleration method, a device and a system, and a storage medium. In the embodiments of the present application, a universal heterogeneous acceleration product is provided, which can be quickly and conveniently compatible with any big data system, and heterogeneous acceleration requirements in the big data system are channeled to the heterogeneous acceleration product provided by the embodiments. The heterogeneous acceleration product can provide a rich operator library, so that heterogeneous acceleration requirements of different big data systems can be more comprehensively covered. In this way, it not only ensures that each big data system can still execute other logics except a heterogeneous acceleration logic according to its personalized requirements, but also effectively saves the development cost of the heterogeneous acceleration logic for each big data system, facilitates the evolution of the heterogeneous acceleration logic, and improves the heterogeneous acceleration performance.

### CROSS-REFERENCE TO RELATED APPLICATIONS

The present application is a National Stage of International Application No. PCT/CN2023/130331, filed on Nov. 8, 2023, which claims priority to Chinese patent application No. 202211505332.6, filed to China National Intellectual Property Administration on Nov. 28, 2022 and entitled “HETEROGENEOUS ACCELERATION METHOD, DEVICE AND SYSTEM, AND STORAGE MEDIUM”. The two applications are hereby incorporated by reference in their entireties.

### TECHNICAL FIELD

The present application relates to the field of data processing technologies and, in particular, to a heterogeneous acceleration method, a device and a system, and a storage medium.

### BACKGROUND

For a big data analysis scenario, as the amount of data becomes larger and the workload becomes more complex, new requirements are put forward for the performance of a big data system. In construction work of large data centers, heterogeneous hardware acceleration components are increasingly used for heterogeneous acceleration. On the one hand, the workload in the big data system can be offloaded to a hardware acceleration card to obtain a higher acceleration ratio, and on the other hand, some CPU pressure can also be released.

At present, each big data system usually has an independent data engine, and a heterogeneous acceleration logic is built in the data engine. This actually leads to repeated development of the heterogeneous acceleration logic, and the heterogeneous acceleration logic enclosed in the data engine is difficult to maintain, which is not conducive to the evolution of the heterogeneous acceleration logic.

### SUMMARY

The present application provides a heterogeneous acceleration method, a device and a system, and a storage medium, so as to implement a universal heterogeneous acceleration product.

An embodiment of the present application provides a heterogeneous acceleration method, including:
receiving a heterogeneous acceleration request sent by any big data system, where the heterogeneous acceleration request includes operator requirement description information;
finding a target operator that is compatible with the operator requirement description information from a preset operator library, where at least one heterogeneous acceleration operator is preset in the operator library;
using an acceleration component pointed to by the target operator to execute the target operator; and
injecting a processing result generated after executing the target operator back into the big data system.

An embodiment of the present application further provides a heterogeneous acceleration device, including a memory, a processor, and at least one acceleration component;
the memory is configured to store one or more computer instructions;
the processor is coupled to the memory and the acceleration component, and is configured to execute the one or more computer instructions to:
receive a heterogeneous acceleration request sent by any big data system, where the heterogeneous acceleration request includes operator requirement description information;
find a target operator that is compatible with the operator requirement description information from a preset operator library, where at least one heterogeneous acceleration operator is preset in the operator library;
use an acceleration component pointed to by the target operator to execute the target operator; and
inject a processing result generated after executing the target operator back into the big data system.

An embodiment of the present application further provides a heterogeneous acceleration system, including a management node with a distributed deployment and multiple computing nodes;
the management node is configured to receive a heterogeneous acceleration request sent by any big data system, where the heterogeneous acceleration request includes operator requirement description information; schedule the heterogeneous acceleration request to a target node of the multiple computing nodes;
the target node is configured to find a target operator that is compatible with the operator requirement description information from a preset operator library, where at least one heterogeneous acceleration operator is preset in the operator library; use an acceleration component pointed to by the target operator to execute the target operator; and inject a processing result generated after executing the target operator back into the big data system.

An embodiment of the present application further provides a computer-readable storage medium storing computer instructions, where when the computer instructions are executed by one or more processors, the one or more processors are caused to perform the aforementioned heterogeneous acceleration method.

In the embodiments of the present application, a universal heterogeneous acceleration product is provided, which can be quickly and conveniently compatible with any big data system, and heterogeneous acceleration requirements in the big data system are channeled to the heterogeneous acceleration product provided by the embodiments. The heterogeneous acceleration product can provide a rich operator library, so that heterogeneous acceleration requirements of different big data systems can be more comprehensively covered. In this way, it not only ensures that each big data system can still execute other logics except a heterogeneous acceleration logic according to its personalized requirements, but also effectively saves the development cost of the heterogeneous acceleration logic for each big data system, facilitates the evolution of the heterogeneous acceleration logic, and improves the heterogeneous acceleration performance.

### BRIEF DESCRIPTION OF THE DRAWINGS

The accompanying drawings described herein are intended to provide further understanding of the present application and constitute a part of the present application. The illustrative embodiments of the present application and their descriptions are used to explain the present application, and do not constitute undue limitation of the present application. The accompanying drawings are as follows.

FIG. 1 is a schematic flowchart of a heterogeneous acceleration method provided by an exemplary embodiment of the present application.

FIG. 2 is a schematic diagram of a scenario of a heterogeneous acceleration solution provided by an exemplary embodiment of the present application.

FIG. 3 is a schematic logical diagram of an application solution provided by an exemplary embodiment of the present application.

FIG. 4 is a schematic structural diagram of a heterogeneous acceleration device provided by another exemplary embodiment of the present application.

FIG. 5 is a schematic structural diagram of a heterogeneous acceleration system provided by still another exemplary embodiment of the present application.

### DESCRIPTION OF EMBODIMENTS

In order to make the purpose, the technical solutions, and the advantages of the present application clearer, the following clearly and completely describes the technical solutions of the present application in conjunction with specific embodiments and corresponding accompanying drawings. Obviously, the described embodiments are only a part of the embodiments of the present application, not all embodiments. Based on the embodiments in the present application, all other embodiments obtained by those of ordinary skill in the art without creative efforts are within the protection scope of the present application.

At present, a heterogeneous acceleration logic is usually enclosed within big data systems, which has problems of repeated development and is not conducive to evolution. To this end, in some embodiments of the present application, a universal heterogeneous acceleration product is provided, which can be quickly and conveniently compatible with any big data system, and heterogeneous acceleration requirements in the big data system are channeled to the heterogeneous acceleration product provided by the embodiments. The heterogeneous acceleration product can provide a rich operator library, so that heterogeneous acceleration requirements of different big data systems can be more comprehensively covered. In this way, it not only ensures that each big data system can still execute other logics except a heterogeneous acceleration logic according to its personalized requirements, but also effectively saves the development cost of the heterogeneous acceleration logic for each big data system, facilitates the evolution of the heterogeneous acceleration logic, and improves the heterogeneous acceleration performance.

The technical solutions provided by the embodiments of the present application are described in detail below in conjunction with the accompanying drawings.

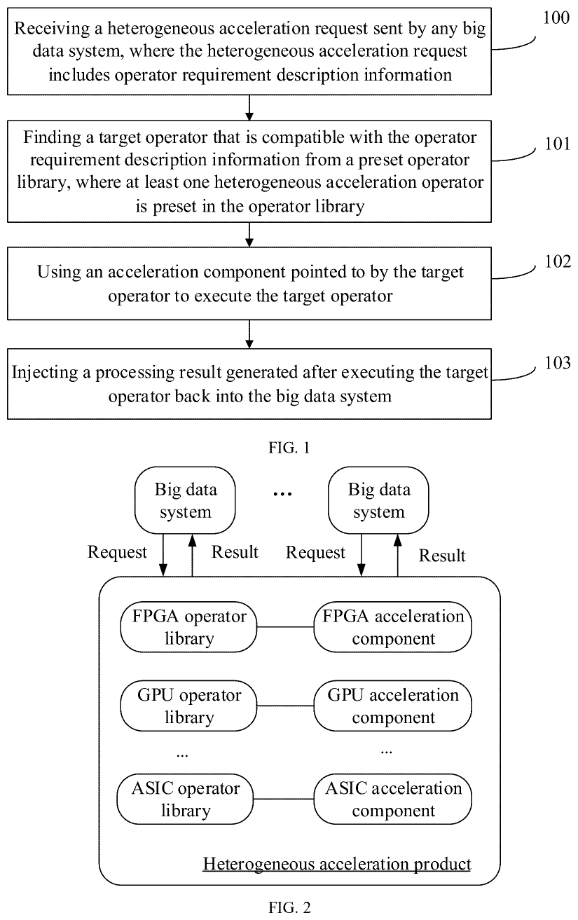

FIG. 1 is a schematic flowchart of a heterogeneous acceleration method provided by an exemplary embodiment of the present application. FIG. 2 is a schematic diagram of a scenario of a heterogeneous acceleration solution provided by an exemplary embodiment of the present application. Referring to FIG. 1, the method may include the following steps.

Step 100: receiving a heterogeneous acceleration request sent by any big data system, where the heterogeneous acceleration request includes operator requirement description information.

Step 101: finding a target operator that is compatible with the operator requirement description information from a preset operator library, where at least one heterogeneous acceleration operator is preset in the operator library.

Step 102: using an acceleration component pointed to by the target operator to execute the target operator.

Step 103: injecting a processing result generated after executing the target operator back into the big data system.

The heterogeneous acceleration method provided by this embodiment may be applied to various scenarios that require heterogeneous acceleration in the field of big data, and this embodiment does not limit the application scenarios.

As introduced in the “BACKGROUND” portion, currently, for a big data system, it is required to distribute the heterogeneous acceleration logic within the data engine, which leads to repeated development of the heterogeneous acceleration logic and is not conducive to the evolution of the heterogeneous acceleration logic.

The inventors found that, during the research process, although data engines of different big data systems seem different, such as spark, presto, etc., these data engines may be basically divided into the following logical components in terms of function.

Language front-end, used to interact an SQL (Structured Query Language, structured query language) statement with an application program.

Intermediate representation (parser/analyzer), used to parse from the SQL statement to obtain a logical execution plan.

Optimizer, used to combine actual actuators and system implementations to convert the logical execution plan into a physical execution plan that can be run in a specific runtime environment, where the physical execution plan includes a series of operators.

Executor, used to execute the physical execution plan determined by the optimizer.

Based on this, the inventors design a universal heterogeneous acceleration product in this embodiment, access the heterogeneous acceleration product provided by this embodiment to a runtime environment of the big data system to replace an actuator in the big data system, and implements a physical execution plan through the universal heterogeneous acceleration product, thereby providing heterogeneous acceleration support for the big data system. It should be understood that the heterogeneous acceleration product provided by this implementation is independent of the big data system, and the heterogeneous acceleration product includes at least one acceleration component. The heterogeneous acceleration product provided by this embodiment can utilize an acceleration component inside the heterogeneous acceleration product to provide a heterogeneous acceleration service for the big data system.

Referring to FIG. 1, in step 100, the heterogeneous acceleration request sent by any big data system may be received. Multiple implementations may be used in this embodiment to ensure the compatibility between the heterogeneous acceleration request and the heterogeneous acceleration product of this embodiment.

The heterogeneous acceleration request may include operator description information, the operator description information may be generated by the big data system according to the physical execution plan outputted by the actuator thereof, and the operator description information is used to describe a property of an operator required for this heterogeneous acceleration request, including but not limited to, an operator type, an operator execution order, etc. For some physical execution plans, memory data of the big data system may be involved, and it is necessary to provide the memory data to the heterogeneous acceleration product in this embodiment. Therefore, the big data system may also carry the memory data in the heterogeneous acceleration request, so as to send the memory data to the heterogeneous acceleration product in this embodiment.

Referring to FIG. 2, in an implementation, the heterogeneous acceleration request may be received using a preset unified interface, and the unified interface supports a specified data format and a specified operator description language. In this implementation, the operator requirement description information may be generated by the big data system according to the specified operator description language, and memory data associated with the operator requirement description information is converted into the specified data format and carried in the heterogeneous acceleration request.

In a practical application, an adapter may be added to the big data system, and the adapter may be implemented in a form of a plug-in, a script, etc. Based on this, the adapter in the big data system may be configured to generate the operator requirement description information for a physical execution plan outputted by an optimizer in the big data system according to the specified operator description language specified in the unified interface provided by this embodiment. For the memory data carried in the heterogeneous acceleration request, the adapter may further be configured to, according to the specified data format specified in the unified interface provided by this embodiment, convert the memory data into the specified data format, and carry the memory data in the heterogeneous acceleration request, so as to send the memory data to the heterogeneous acceleration product in this embodiment.

In this way, in this implementation, it may use the unified interface to specify language requirement and data format requirement for the heterogeneous acceleration request, and the big data system may send the heterogeneous acceleration request that meets requirements according to provisions of the unified interface, thereby ensuring the compatibility between the heterogeneous acceleration request and the heterogeneous acceleration product of this embodiment.

In another implementation, a compatibility component may be provided in the heterogeneous acceleration product provided by this embodiment, and the compatibility component is configured to receive the heterogeneous acceleration request. Then, it may use the compatibility component to identify a data format and an operator description language actually used in the heterogeneous acceleration request, convert the data format used in the heterogeneous acceleration request into the specified data format, and convert the operator description language used in the heterogeneous acceleration request into the specified operator description language.

In this implementation, the heterogeneous acceleration product can actively compatible with languages and data formats used by different big data systems, and uniformly convert heterogeneous acceleration requests sent by different big data systems into specified languages and data formats, thereby ensuring the compatibility between the heterogeneous acceleration requests and the heterogeneous acceleration product of this embodiment.

Of course, in this embodiment, other implementations may also be used to ensure the compatibility between the heterogeneous acceleration request and the heterogeneous acceleration product of this embodiment, and this embodiment is not limited thereto.

In the heterogeneous acceleration product provided by this embodiment, the specified data format may be a vector data format, for example, a columnar memory layout format. By adopting a vector-based columnar memory data structure and columnar execution, a vectorized computing capability of a CPU based on deep-pipelined (deep-pipelined) design and SIMD instruction set can be maximally used.

Continuing to refer to FIG. 1, in step 101, the target operator that is compatible with the operator requirement description information may be found from the preset operator library. In this embodiment, at least one heterogeneous acceleration operator may be preset in the operator library. In order to improve the versatility, preferably, the heterogeneous acceleration operator in the operator library may cover heterogeneous acceleration requirements of various big data systems as comprehensively as possible. In this embodiment, the operator library may include a field-programmable gate array (FPGA) operator library, a graphics processing unit (GPU) operator library, and/or an application specific integrated circuit (ASIC) operator library. Each heterogeneous acceleration operator in the FPGA operator library points to an FPGA acceleration component; each heterogeneous acceleration operator in the GPU operator library points to a GPU acceleration component; and each heterogeneous acceleration operator in the ASIC operator library points to an ASIC acceleration component. Exemplarily, the FPGA operator library may include a Filter operator, etc., the GPU operator library may include a join operator, etc., and the ASIC operator library may include a decompression/compression operator, an encryption/decryption operator, etc.

It should be understood that the operator description information provided by the big data system usually only reveals a required operator operation logic, and one operator operation logic may be implemented using multiple kinds of heterogeneous acceleration operators, but the implementation effect may be different. Therefore, it is proposed in step 101 to find the target operator that is compatible with the operator requirement description information from the operator library.

In an exemplary finding solution: at least one candidate operator meeting the operator requirement description information may be searched for from the operator library, and from the at least one candidate operator, an operator with a highest compatibility degree with the operator requirement description information is selected as the target operator. The candidate operator may be any heterogeneous acceleration operator in the operator library that can implement an operator operation logic indicated by the operator requirement description information. In this exemplary finding solution, a compatibility rule may be pre-configured, and the compatibility rule may set a compatibility degree of each heterogeneous acceleration operator to each type of operator operation logic, and the compatibility degree may be an empirical value, or may be calculated in real time by setting a relevant calculation strategy, which is not limited herein. In this way, after determining which type of operator operation logic is indicated by the operator requirement description information, the compatibility between each candidate operator and current operator requirement description information may be determined, and the candidate operator with the highest compatibility degree may be selected as the target operator.

Through the finding solution provided by this embodiment, the heterogeneous acceleration request in the big data system can be optimized to an appropriate heterogeneous acceleration operator, so as to achieve a better heterogeneous operator configuration.

In addition, considering that some heterogeneous acceleration requests may need to call data from a storage system, preferably, in this embodiment, the operator requirement description information may also be parsed to determine whether it is necessary for the heterogeneous acceleration request to call data from the storage system, and if it is necessary, during an execution of the target operator, data required for the execution of the target operator is acquired from the storage system.

Referring to FIG. 2, the heterogeneous acceleration product provided by the present embodiment may be interfaced with the storage system and may pull data from the storage system as required. The storage system that may be interfaced with in this embodiment may include but is not limited to, a hadoop distributed file system (HDFS), an object storage service (OSS), or other object storage products on a cloud, etc., and this embodiment does not limit the type of the storage system.

In this way, in this embodiment, data that the target operator needs to calculate may be acquired from a memory of an underlying storage system or the big data system. In addition, in this embodiment, multiple data types may be supported. For example, various data types, such as upper-level application representation scalars and complex nesting, may be allowed.

On this basis, referring to FIG. 1, in step 102, the acceleration component pointed to by the target operator may be used to execute the target operator. In this embodiment, all heterogeneous acceleration operators in the operator library may point to acceleration components, and the acceleration components are heterogeneous hardware used to support heterogeneous acceleration. The acceleration component in this embodiment may include but is not limited to, an FPGA, a GPU, an ASIC, etc.

It should be noted that the heterogeneous acceleration product provided by this embodiment may be understood as a combination of software and hardware. The software may be a heterogeneous acceleration engine corresponding to the heterogeneous acceleration product, the hardware corresponds to the aforementioned acceleration component, and the acceleration component may be called to execute the heterogeneous acceleration operator through the heterogeneous acceleration engine. The heterogeneous acceleration engine may control the acceleration component pointed to by the target operator to perform the above-mentioned work of acquiring the data that needs to be calculated. After acquiring the data required for the execution of the target operator, the acceleration component pointed to by the target operator may initiate the execution of the target operator, and generate the processing result.

In step 103, the processing result generated after executing the target operator may be injected back into the big data system. The heterogeneous acceleration product provided by this embodiment is independent of the big data system, therefore, the heterogeneous acceleration processing result generated outside the big data system needs to be injected back into the big data system.

As mentioned above, the heterogeneous acceleration product provided by this embodiment may access the runtime environment of the big data system. Therefore, the acceleration component in the heterogeneous acceleration product may provide the generated processing result to the runtime environment of the big data system, so that the processing result is injected back into an original processing link of the big data system for the big data system to continue to execute a subsequent processing logic.

So far, the heterogeneous acceleration product provided by this embodiment can be independent of the big data system and replace the actuator inside the big data system to provide an external heterogeneous acceleration service for the big data system.

Based on the independence of the heterogeneous acceleration product provided by this embodiment, in this embodiment, an update request for the operator library may also be received, and according to the update request, at least one of the following operations is performed on the heterogeneous acceleration operator in the operator library: addition, deletion and modification. That is, the operator library in this embodiment may be evolved, and the heterogeneous acceleration operator in the operator library may also be evolved, which enables the heterogeneous acceleration product provided by this embodiment to be flexibly updated and continuously optimized, thereby continuously improving the heterogeneous acceleration performance.

In addition, the heterogeneous acceleration product provided by this embodiment may also support a resource management function internally. Therefore, in this embodiment, a respective resource usage state corresponding to each acceleration component supporting the target operator may also be acquired, and according to a preset resource scheduling strategy, a target acceleration component is selected from the acceleration component supporting the target operator as the acceleration component pointed to by the target operator. That is, in this embodiment, the scheduling of the acceleration component can be performed according to the resource usage state of each acceleration component, so as to optimize resource configuration and improve product performance.

In summary, in this embodiment, a universal heterogeneous acceleration product can be provided, which can be quickly and conveniently compatible with any big data system, and heterogeneous acceleration requirements in the big data system are channeled to the heterogeneous acceleration product provided by the embodiments. The heterogeneous acceleration product can provide a rich operator library, so that heterogeneous acceleration requirements of different big data systems can be more comprehensively covered. In this way, it not only ensures that each big data system can still execute other logics except a heterogeneous acceleration logic according to its personalized requirements, but also effectively saves the development cost of the heterogeneous acceleration logic for each big data system, facilitates the evolution of the heterogeneous acceleration logic, and improves the heterogeneous acceleration performance.

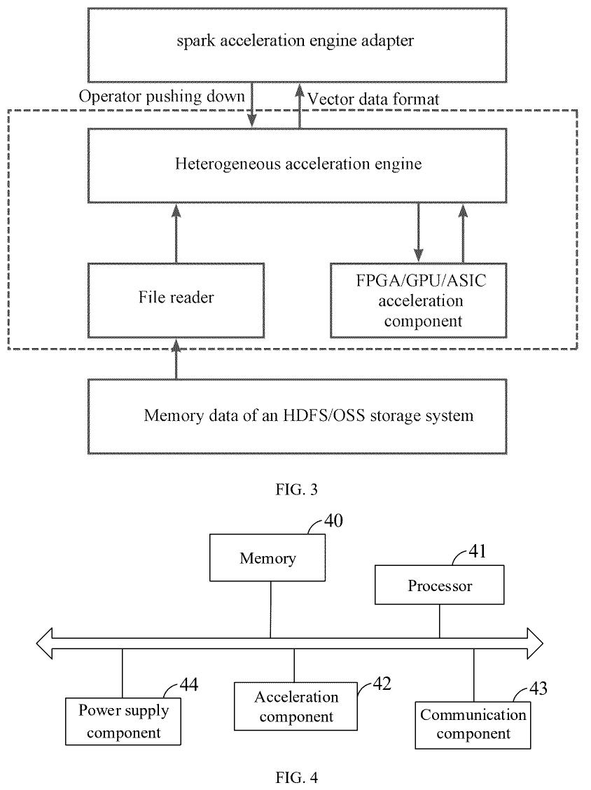

FIG. 3 is a schematic logical diagram of an application solution provided by an exemplary embodiment of the present application. Referring to FIG. 3, in this application solution, a big data system spark is taken as an example. In this application solution, the following devices and operations are included.
A. a spark acceleration engine adapter (which may be deployed in the spark in a form of plug-in).
   1.1 receive a user request, parse sql and generate an execution plan using an optimizer, and push down and unify an operator suitable for a heterogeneous acceleration engine to the heterogeneous acceleration engine, such as a filter.
   1.2 convert data that needs to be calculated into a unified data specification required by the acceleration engine.
B. a universal heterogeneous acceleration product provided by the embodiments (dashed box part in FIG. 3).
   1. receive an operator that needs to be calculated and parse data corresponding to the operator.
   2. acquire data that needs to be calculated from an underlying storage system or memory data by using a built-in file reader.
   3. search for a target operator from an operator library to execute an operator pushed down from an upper layer spark, such as a filter operator in an FPGA operator library, a join operator in a GPU operator library, a decompression/compression operator, an encryption/decryption operator in an ASIC operator library, so as to achieve better execution speed.
   4. an FPGA/GPU/ASIC acceleration component receives data, initiates an operator execution, and outputs a returned result to a runtime environment of the heterogeneous acceleration product.
   5. the runtime environment returns data to the acceleration engine adapter.
   6. an upper-layer application such as spark continues to perform a subsequent calculation.

Through the above application solution, it can be seen that spark no longer needs to use its internal actuator to undertake a heterogeneous acceleration work, but can be interfaced with the spark without barriers through the heterogeneous acceleration product provided by this embodiment, provide heterogeneous acceleration support for the spark, and the processing result of heterogeneous acceleration may also be injected back into the spark without barriers.

It should be noted that the execution subject of each step of the method provided by the above embodiments may be the same device, or the method may also be executed by different devices. In addition, in some of the processes described in the above embodiments and the accompanying drawings, multiple operations appearing in a specific order are included. However, it should be clearly understood that these operations may not be executed in the order they appear in this specification or may be executed in parallel. The serial numbers of the operations, such as 101, 102, etc., are only used to distinguish different operations, and the serial numbers themselves do not represent any execution order. In addition, these processes may include more or fewer operations, and these operations may be executed sequentially or in parallel.

From the perspective of product deployment, the heterogeneous acceleration product provided by the above embodiments may be deployed on a distributed system or a single cloud computing node.

For a case of deployment on a single computing node, FIG. 4 is a schematic structural diagram of a heterogeneous acceleration device provided by another exemplary embodiment of the present application. Referring to FIG. 4, the heterogeneous acceleration device may include: a memory 40, a processor 41, and at least one acceleration component 42.

The processor 41 is coupled to the memory 40 and the acceleration component 42, and is configured to execute a computer program in the memory 40 to:
receive a heterogeneous acceleration request sent by any big data system, where the heterogeneous acceleration request includes operator requirement description information;
find a target operator that is compatible with the operator requirement description information from a preset operator library, where at least one heterogeneous acceleration operator is preset in the operator library;
use an acceleration component pointed to by the target operator to execute the target operator; and
inject a processing result generated after executing the target operator back into the big data system.

Various types of acceleration components may be assembled on the heterogeneous acceleration device to support various types of heterogeneous acceleration operators in the operator library. The heterogeneous acceleration operators in the operator library in this embodiment may be as comprehensive as possible to cover heterogeneous acceleration requirements of various big data systems, and correspondingly, the acceleration component may also be as comprehensive as possible. In addition, in order to ensure the heterogeneous acceleration efficiency, in this embodiment, the number of various acceleration components assembled on the heterogeneous acceleration device is not limited, and may be configured as required.

In this embodiment, a heterogeneous acceleration engine may be provided, and the processor 41 may run the heterogeneous acceleration engine to cooperate with relevant acceleration components to implement the above processing logic. In this embodiment, the heterogeneous acceleration engine may run on the same computing device as the big data system to provide a local heterogeneous acceleration service for the big data system. Of course, the heterogeneous acceleration engine may also run on a different computing device from the big data system to provide a remote heterogeneous acceleration service for the big data system, which is not limited in this embodiment.

In an embodiment, in the process of receiving the heterogeneous acceleration request sent by any big data system, the processor 41 may be configured to:
receive the heterogeneous acceleration request using a preset unified interface, where the unified interface supports a specified data format and a specified operator description language;
where the operator requirement description information is generated by the big data system according to the specified operator description language; memory data associated with the operator requirement description information is converted into the specified data format and carried in the heterogeneous acceleration request.

In an embodiment, the processor 41 may be further configured to:
parse the operator requirement description information to determine whether it is necessary for the heterogeneous acceleration request to call data from a storage system; and
if it is necessary, during an execution of the target operator, acquire data required for the execution of the target operator from the storage system.

In an embodiment, in the process of finding the target operator that is compatible with the operator requirement description information from the preset operator library, the processor 41 may be configured to:
search for at least one candidate operator meeting the operator requirement description information from the operator library; and
select, from the at least one candidate operator, an operator with a highest compatibility degree with the operator requirement description information as the target operator.

In an embodiment, the operator library includes an FPGA operator library, a GPU operator library and/or an ASIC operator library; each heterogeneous acceleration operator in the FPGA operator library points to an FPGA acceleration component; each heterogeneous acceleration operator in the GPU operator library points to a GPU acceleration component; and each heterogeneous acceleration operator in the ASIC operator library points to an ASIC acceleration component.

In an embodiment, when injecting the processing result generated after executing the target operator back into the big data system, the processor 41 may be configured to:
receive, by using a current runtime environment, the processing result returned by the acceleration component executing the target operator; and
return the processing result to the big data system.

In an embodiment, the processor 41 may be further configured to:
receive an update request for the operator library; and
perform, according to the update request, at least one of the following operations on the heterogeneous acceleration operator in the operator library: addition, deletion and modification.

In an embodiment, the processor 41 may be further configured to:
acquire a respective resource usage state corresponding to each acceleration component supporting the target operator; and
select, according to a preset resource scheduling strategy, a target acceleration component from each acceleration component supporting the target operator as the acceleration component pointed to by the target operator.

In an embodiment, each acceleration component supporting the operator library is deployed in a distributed system or a cloud computing node.

In an embodiment, the processor 41 may be further configured to:
identify, by using a compatibility component, a data format and an operator description language adopted by the heterogeneous acceleration request;
convert the data format adopted by the heterogeneous acceleration request into a specified data format; and
convert the operator description language adopted by the heterogeneous acceleration request into a specified operator description language.

It should be noted that technical details of the above embodiments of heterogeneous acceleration device may be referred to the relevant descriptions in the aforementioned method embodiments, which are not repeated herein in order to save space, but this should not cause a loss of the scope of protection of the present application.

Further, as shown in FIG. 4, the heterogeneous acceleration device further includes other components such as a communication component 43 and a power supply component 44. FIG. 4 only schematically shows some components, which does not mean that the heterogeneous acceleration device only includes the components shown in FIG. 4.

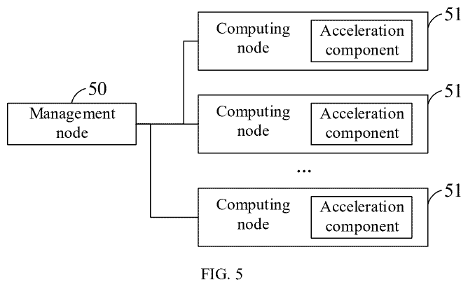

For a case of deployment in a distributed system, FIG. 5 is a schematic structural diagram of a heterogeneous acceleration system provided by still another exemplary embodiment of the present application. Referring to FIG. 5, in this embodiment, a management node 50 and multiple computing nodes 51 may be configured in a distributed system, the multiple computing nodes may be inserted with a full quantity or a non-full quantity of acceleration components, and the full quantity refers to all types. The types of the acceleration components in this embodiment may include but are not limited to, an FPGA acceleration component, a GPU acceleration component, an ASIC acceleration component, etc.

The management node 50 can be configured to receive a heterogeneous acceleration request sent by any big data system, where the heterogeneous acceleration request includes operator requirement description information; schedule the heterogeneous acceleration request to a target node of the multiple computing nodes.

The target node 51 can be configured to find a target operator that is compatible with the operator requirement description information from a preset operator library, where at least one heterogeneous acceleration operator is preset in the operator library; use an acceleration component pointed to by the target operator to execute the target operator; and inject a processing result generated after executing the target operator back into the big data system.

In this embodiment, a heterogeneous acceleration engine may be loaded on each computing node 51, and the computing node 51 may respond to the heterogeneous acceleration request scheduled by the management node 50 by running the heterogeneous acceleration engine. In addition, the acceleration component plugged into each computing node 51 may be of all types, and may also not be of all types. In a case of a non-full type, in a process of scheduling the heterogeneous acceleration request, the management node 50 may preliminarily identify types of acceleration components that may be required for the heterogeneous acceleration request, and schedule the heterogeneous acceleration request to the computing node 51 into which these types of acceleration components are plugged, so as to ensure that the heterogeneous acceleration system provided by this embodiment can smoothly respond to the heterogeneous acceleration request.

In this embodiment, the processing logic of the computing node 51 after receiving the heterogeneous acceleration request is similar to that of the heterogeneous acceleration device shown in FIG. 4, which is not repeated here.

It should be note that the technical details of the embodiments of the above heterogeneous acceleration system can be found in the relevant descriptions of the method embodiments. In order to save space, these details will not be repeated here, which should not cause loss to the protection scope of the present application.

Correspondingly, an embodiment of the present application further provides a computer-readable storage medium storing a computer program, where when the computer program is executed, the steps that can be executed by the heterogeneous acceleration device in the above method embodiments can be implemented.

The memory shown in FIG. 4 is configured to store a computer program and can be configured to store various other data to support operations on a computing platform. Examples of the data include instructions for any application or method used to operate on the computing platform, contact data, phonebook data, messages, images, videos, etc. The memory may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk.

The communication component in FIG. 4 is configured to facilitate wired or wireless communication between a device where the communication component is located and other devices. The device where the communication component is located may access a wireless network based on a communication standard, such as wireless fidelity (WiFi), second generation (2G), third generation (3G), fourth generation (4G)/long term evolution (LTE), or fifth generation (5G), or a combination thereof. In an exemplary embodiment, the communication component receives a broadcast signal or broadcast related information from an external broadcast management system via a broadcast channel. In an exemplary embodiment, the communication component also includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology, and other technologies.

The power supply component in FIG. 4 supplies power to various components of a device where the power supply component is located. The power supply component may include a power management system, one or more power supplies, and other components associated with generating, managing, and distributing power for the device where the power supply component is located.

Those skilled in the art should understand that embodiments of the present application may be provided as a method, a system, or a computer program product. Therefore, the present application may take a form of an embodiment entirely in hardware, an embodiment entirely in software, or an embodiment combining software and hardware aspects. Moreover, the present application may take a form of a computer program product implemented on one or more computer usable storage media (including but not limited to a disk memory, a CD-ROM, an optical memory, etc.) including computer usable program code.

The present application is described with reference to flowcharts and/or block diagrams of the methods, devices (systems), and computer program products according to the embodiments of the present application. It should be understood that each flow and/or block in the flowcharts and/or block diagrams, and combinations of flows and/or blocks in the flowcharts and/or block diagrams may be implemented by computer program instructions. These computer program instructions may be provided to a processor of a general-purpose computer, a special-purpose computer, an embedded processor, or other programmable data processing devices to generate a machine, so that the instructions executed by the processor of the computer or the other programmable data processing devices generate an apparatus for implementing functions specified in one or more flows of the flowcharts and/or one or more blocks of the block diagrams.

These computer program instructions may also be stored in a computer-readable memory that can guide the computer or the other programmable data processing devices to work in a specific manner, so that the instructions stored in the computer-readable memory generate a manufactured product including an instruction apparatus, and the instruction apparatus implements functions specified in one or more flows of the flowcharts and/or one or more blocks of the block diagrams.

These computer program instructions may also be loaded onto the computer or the other programmable data processing devices, so that a series of operation steps are executed on the computer or the other programmable devices to generate computer-implemented processing, and thus the instructions executed on the computer or the other programmable devices provide steps for implementing functions specified in one or more flows of the flowcharts and/or one or more blocks of the block diagrams.

In a typical configuration, a computing device includes one or more processors (CPUs), an input/output interface, a network interface, and a memory.

The memory may include forms such as a non-permanent memory, a random access memory (RAM), and/or a non-volatile memory, such as a read-only memory (ROM) or a flash memory (flash RAM), in computer-readable media. The memory is an example of a computer-readable medium.

The computer-readable media, including permanent and non-permanent, removable and non-removable media, may implement information storage by any method or technology. Information may be computer-readable instructions, data structures, modules of programs, or other data. Examples of storage media for computers include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a read-only compact disk read-only memory (CD-ROM), a digital versatile disk (DVD) or other optical storage, a magnetic-cartridge tape, a magnetic-tape disk storage or other magnetic storage devices, or any other non-transmission media that may be used to store information that can be accessed by computing devices. According to the definition herein, the computer-readable media do not include transitory computer-readable media (transitory media), such as modulated data signals and carriers.

It should also be noted that terms “including”, “comprising”, or any other variations thereof are intended to cover non-exclusive inclusion, such that a process, method, commodity or device including a series of elements not only includes those elements, but also includes other elements that are not explicitly listed, or also includes elements inherent to such process, method, commodity or device. Without further limitations, an element defined by a statement “including a/an/one . . . ” does not exclude the existence of other identical elements in the process, method, commodity or device including that element.

Those described above are only embodiments of the present application, and are not intended to limit the present application. For those skilled in the art, the present application may have various modifications and variations. Any modifications, equivalent substitutions, improvements, etc., made within the spirit and principles of the present application, shall be included within the protection scope of the present application.

1. A heterogeneous acceleration method, applied to a heterogeneous acceleration device, wherein the heterogeneous acceleration device comprises at least one acceleration component, and the method comprises:
receiving a heterogeneous acceleration request sent by any big data system, wherein the heterogeneous acceleration request comprises operator requirement description information;
finding a target operator that is compatible with the operator requirement description information from a preset operator library, wherein at least one heterogeneous acceleration operator is preset in the operator library;
using an acceleration component pointed to by the target operator to execute the target operator; and
injecting a processing result generated after executing the target operator back into the big data system.

2. The method according to claim 1, wherein the receiving the heterogeneous acceleration request sent by any big data system comprises:
receiving the heterogeneous acceleration request using a preset unified interface, wherein the unified interface supports a specified data format and a specified operator description language;
wherein the operator requirement description information is generated by the big data system according to the specified operator description language; the heterogeneous acceleration request further includes memory data associated with the operator requirement description information, and the memory data conforms to the specified data format.

3. The method according to claim 1, further comprising:
parsing the operator requirement description information to determine whether it is necessary for the heterogeneous acceleration request to call data from a storage system; and
if it is necessary, during an execution of the target operator, acquiring data required for the execution of the target operator from the storage system.

4. The method according to claim 1, wherein the finding the target operator that is compatible with the operator requirement description information from the preset operator library comprises:
searching for at least one candidate operator meeting the operator requirement description information from the operator library; and
selecting, from the at least one candidate operator, an operator with a highest compatibility degree with the operator requirement description information as the target operator.

5. The method according to claim 1, wherein the operator library comprises a field-programmable gate array (FPGA) operator library, a graphics processing unit (GPU) operator library and/or an application specific integrated circuit (ASIC) operator library; each heterogeneous acceleration operator in the FPGA operator library points to an FPGA acceleration component; each heterogeneous acceleration operator in the GPU operator library points to a GPU acceleration component; and each heterogeneous acceleration operator in the ASIC operator library points to an ASIC acceleration component.

6. The method according to claim 1, wherein the injecting the processing result generated after executing the target operator back into the big data system comprises:
receiving, by using a current runtime environment, the processing result returned by the acceleration component executing the target operator; and
returning the processing result to the big data system.

7. The method according to claim 1, further comprising:
receiving an update request for the operator library; and
performing, according to the update request, at least one of the following operations on the heterogeneous acceleration operator in the operator library: addition, deletion and modification.

8. The method according to claim 1, further comprising:
acquiring a respective resource usage state corresponding to each acceleration component supporting the target operator; and
selecting, according to a preset resource scheduling strategy, a target acceleration component from each acceleration component supporting the target operator as the acceleration component pointed to by the target operator.

9. The method according to claim 1, wherein each acceleration component supporting the operator library is deployed in a distributed system or a cloud computing node.

10. The method according to claim 1, further comprising:
identifying, by using a compatibility component, a data format and an operator description language adopted by the heterogeneous acceleration request;
converting the data format adopted by the heterogeneous acceleration request into a specified data format; and
converting the operator description language adopted by the heterogeneous acceleration request into a specified operator description language.

11. The method according to claim 1, wherein the heterogeneous acceleration device is independent of the big data system.

12. A heterogeneous acceleration device, comprising a memory, a processor, and at least one acceleration component;
the memory is configured to store one or more computer instructions;
the processor is coupled to the memory and the acceleration component, and is configured to execute the one or more computer instructions to:
receive a heterogeneous acceleration request sent by any big data system, wherein the heterogeneous acceleration request comprises operator requirement description information;
find a target operator that is compatible with the operator requirement description information from a preset operator library, wherein at least one heterogeneous acceleration operator is preset in the operator library;
use an acceleration component pointed to by the target operator to execute the target operator; and
inject a processing result generated after executing the target operator back into the big data system.

13. A heterogeneous acceleration system, comprising a management node with a distributed deployment and multiple computing nodes;
the management node is configured to receive a heterogeneous acceleration request sent by any big data system, wherein the heterogeneous acceleration request comprises operator requirement description information; schedule the heterogeneous acceleration request to a target node of the multiple computing nodes;
the target node is configured to find a target operator that is compatible with the operator requirement description information from a preset operator library, wherein at least one heterogeneous acceleration operator is preset in the operator library; use an acceleration component pointed to by the target operator to execute the target operator; and inject a processing result generated after executing the target operator back into the big data system.

14. A non-transitory computer-readable storage medium storing computer instructions, wherein when the computer instructions are executed by one or more processors, the one or more processors are caused to perform the heterogeneous acceleration method according to claim 1.

15. The device according to claim 12, wherein the processor is configured to:
receive the heterogeneous acceleration request using a preset unified interface, wherein the unified interface supports a specified data format and a specified operator description language;
wherein the operator requirement description information is generated by the big data system according to the specified operator description language; the heterogeneous acceleration request further includes memory data associated with the operator requirement description information, and the memory data conforms to the specified data format.

16. The device according to claim 12, wherein the processor is configured to:
parse the operator requirement description information to determine whether it is necessary for the heterogeneous acceleration request to call data from a storage system; and
if it is necessary, during an execution of the target operator, acquire data required for the execution of the target operator from the storage system.

17. The device according to claim 12, wherein the processor is configured to:
search for at least one candidate operator meeting the operator requirement description information from the operator library; and
select, from the at least one candidate operator, an operator with a highest compatibility degree with the operator requirement description information as the target operator.

18. The device according to claim 12, wherein the operator library comprises a field-programmable gate array (FPGA) operator library, a graphics processing unit (GPU) operator library and/or an application specific integrated circuit (ASIC) operator library; each heterogeneous acceleration operator in the FPGA operator library points to an FPGA acceleration component; each heterogeneous acceleration operator in the GPU operator library points to a GPU acceleration component; and each heterogeneous acceleration operator in the ASIC operator library points to an ASIC acceleration component.

19. The device according to claim 12, wherein the processor is configured to:
receive, by using a current runtime environment, the processing result returned by the acceleration component executing the target operator; and
return the processing result to the big data system.

20. The device according to claim 12, wherein the processor is configured to:
receive an update request for the operator library; and perform, according to the update request, at least one of the following operations on the heterogeneous acceleration operator in the operator library: addition, deletion and modification.
